(19) United States
(12) Patent Application Publication
(10) Pub. No.: US 2024/0354426 A1
(43) Pub. Date: Oct. 24, 2024

(54) Generating and Distributing Security Policies in Containerized Environments

(71) Applicant: Dell Products L.P., Round Rock, TX (US)

(72) Inventors: Igor Dubrovsky, Be’er-Sheva (IL); Boris Shpilyuck, Ashdod (IL); Stav Sapir, Beer Sheba (IL)

(21) Appl. No.: 18/302,757

(22) Filed: Apr. 18, 2023

(51) Int. Cl. G06F 21/60; G06F 8/658; G06F 21/62

(52) U.S. Cl. CPC G06F 21/604; G06F 8/658; G06F 21/6236

(57) ABSTRACT

A system can identify that computer-executable code for a microservice has been created or modified, wherein the microservice is part of a group of microservices that are configured to be executed in a containerized environment. The system can determine, from the computer-executable code, policy access rules for the microservice. The system can generate an access policy based on the policy access rules according to a first format of a first target system type, wherein the system is configured to generate access policies according to a group of formats that comprise the first format. The system can, at a time that the microservice is executed in the containerized environment, inject the access policy into the containerized environment, wherein access to the microservice is restricted based on the access policy.

### BACKGROUND

A computer application or service can comprise multiple microservices, which can operate together to provide the application or service.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can identify that computer-executable code for a microservice has been created or modified, wherein the microservice is part of a group of microservices that are configured to be executed in a containerized environment. The system can determine, from the computer-executable code, policy access rules for the microservice. The system can generate an access policy based on the policy access rules according to a first format of a first target system type, wherein the system is configured to generate access policies according to a group of formats that comprise the first format. The system can, at a time that the microservice is executed in the containerized environment, inject the access policy into the containerized environment, wherein access to the microservice is restricted based on the access policy.

An example method can comprise determining, by a system comprising a processor, policy access rules for a microservice based on computer-executable code for the microservice. The method can further comprise generating, by the system, an access policy based on the policy access rules according to a format of a first target system type, wherein the system is configured to generate access policies according to a group of formats that comprise the format. The method can further comprise inserting, by the system, the access policy into a containerized environment in which the microservice executes, wherein access to the microservice is restricted based on the access policy.

An example non-transitory computer-readable medium can comprise instructions that, in response to execution, cause a system comprising a processor to perform operations. These operations can comprise determining policy access rules for a microservice based on computer-executable code for the microservice. These operations can further comprise generating an access policy based on the policy access rules according to a format of a first target system type. These operations can further comprise loading the access policy into a containerized environment in which the microservice executes, wherein access to the microservice is restricted based on the access policy.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate generating and distributing security policies in a containerized environment, in accordance with an embodiment of this disclosure;

FIG. 2 illustrates another example system architecture that can facilitate generating and distributing security policies in a containerized environment, in accordance with an embodiment of this disclosure;

FIG. 3 illustrates an example process flow that can facilitate generating and distributing security policies in a containerized environment, in accordance with an embodiment of this disclosure;

FIG. 4 illustrates another example process flow that can facilitate generating and distributing security policies in a containerized environment, in accordance with an embodiment of this disclosure;

FIG. 5 illustrates another example process flow that can facilitate generating and distributing security policies in a containerized environment, in accordance with an embodiment of this disclosure;

FIG. 6 illustrates another example process flow that can facilitate generating and distributing security policies in a containerized environment, in accordance with an embodiment of this disclosure;

FIG. 7 illustrates another example process flow that can facilitate generating and distributing security policies in a containerized environment, in accordance with an embodiment of this disclosure;

FIG. 8 illustrates another example process flow that can facilitate generating and distributing security policies in a containerized environment, in accordance with an embodiment of this disclosure;

FIG. 9 illustrates another example process flow that can facilitate generating and distributing security policies in a containerized environment, in accordance with an embodiment of this disclosure;

FIG. 10 illustrates another example process flow that can facilitate generating and distributing security policies in a containerized environment, in accordance with an embodiment of this disclosure;

FIG. 11 illustrates another example process flow that can facilitate generating and distributing security policies in a containerized environment, in accordance with an embodiment of this disclosure;

FIG. 12 illustrates an example block diagram of a computer operable to execute an embodiment of this disclosure.

### DETAILED DESCRIPTION

### Overview

Containerization can comprise packaging executable computer code (e.g., a microservice) with libraries and dependencies that are invoked by the code. A container can be viewed in contrast with a virtual machine, where code is packaged with an operating system image. A microservice can comprise an instance of a container that works in conjunction with other instances of other containers to provide a computing service.

The present techniques can be implemented to automatically tighten security within a containerized and decentralized environment by facilitating auto-generation of access policies.

A prior approach to this type of security can involve manually creating access policies (sometimes referred to as rules) in container orchestrator systems. In these prior approaches, an access policy can manage user access to a computing service, such as based on role-based access control (RBAC) rules. A problem with this approach is that it can be manually intensive and time consuming, where an administrator can need to know about the mechanism being used and need to create an access policy with the correct restrictions.

Another prior approach to this type of security can involve a central identity access management (IAM) service, where an administrator can define access permissions for the whole of a protected system. This approach can have a problem similar to that of the other prior approach discussed. Another problem with this approach can be that a centralized IAM service negatively affects performance, and becomes a single point of failure for the protected system.

Another prior approach to this type of security can involve a framework of a programming language that has a built-in language for access checks. A problem with this approach can be that it is tightly coupled to a specific language and/or framework, and does not provide a separation between business and security layers at runtime.

The present techniques, then, can address creating a polyglot system that can automatically generate access policies based on a definition in code, support different rule engines, and distribute and use the created policies in a decentralized environment.

In an example, the present techniques can be implemented so that, during deploy time (as opposed to at run time), upon creation (or code change) of a microservice, a system can analyze the source ode of the microservice to determine a set of access rules for it based on source code structure, rules defined in an expression language, and/or rules files.

A system that implements the present techniques can use this information to automatically generate access policies with respect to a target rule engine (where the system can be configured to generate access policies in multiple formats with respect to multiple types of target rule engines). In some examples, policy generation output can be produced in a configuration language (e.g., a JavaScript Object Notation (JSON), a Yet Another Markup Language (YAML), or an Extensible Markup Language (XML) format, where the configuration file can be in a human-readable format), and/or or a programming language. In some examples, at run time (as opposed to at deploy time), those code files can be injected into a side car container that works with a corresponding rules engine.

Creating policies within a containerized environment can have the following problems, which can be mitigated by implementing the present techniques.

Creating policies manually can have a problem of introducing risks, as well as being inefficient. Creating policies manually can introduce risks associated with human mistakes—e.g., an administrator might forget to create a network policy, or create it incorrectly so that the policy permits wider access than is required. It can be that a change of business logic in terms of accessed microservices can require modifying already created policies. For an application or service that comprises hundreds or thousands of microservices, this can involve significant and error-prone manual labor.

There can be a problem with multiple types of rule engines being deployed for containerized environments. In a containerized environment, a new component can be shipped to a user as a helm chart that includes business parts of a product. A rule engine can already exist, which can support one type of policy language. Changing to a new rule engine can involve time and effort, and installing a second rule engine alongside a preexisting rule engine can squander computing resources.

Another problem can relate to policies being defined in a way that is unsuitable for all the programmer source ecosystem and a reviewer person. The present techniques can take into account that a policy can be created by a programmer, so there should be an ability to code it, in a manner suitable for a programming person ecosystem. Additionally, the present techniques can take into account that a policy can be reviewed and changed by a non-programmer (e.g., someone in an information technology (IT) role, or a team of a security office of an organization).

Another problem can relate to a lack of performing an access decision in a distributed way as close as possible (or close) to protected resources. Having a single policy decision point, as in a IAM approach, can affect performance and introduce a single point of failure to a system. In a distributed system, according to the present techniques, respective risks of failure can be spread so that there is not a single point of failure.

The present techniques can facilitate automatically generating access policies that target a specific rule engine in a decentralized manner. This can result in a more reliable and secure system relative to prior approaches, reduce or eliminate manual labor involved in creation and management of access policies, and contribute to an overall solution maturity.

The present techniques can be implemented to apply static code analysis to automatically generate access policies to secure access to a particular microservice based on existing access policies, expression language in the microservice code, and/or the microservice code.

A rule analyzer component can analyze access restrictions on the source code and configuration. A target policy generator component and a policy distributor component can, respectively, generate access policies automatically based on discovered access restrictions, and propagate the generated access policies to a target container orchestrator/service mesh, such as via side cars integrated with rule engines.

### Example Architectures

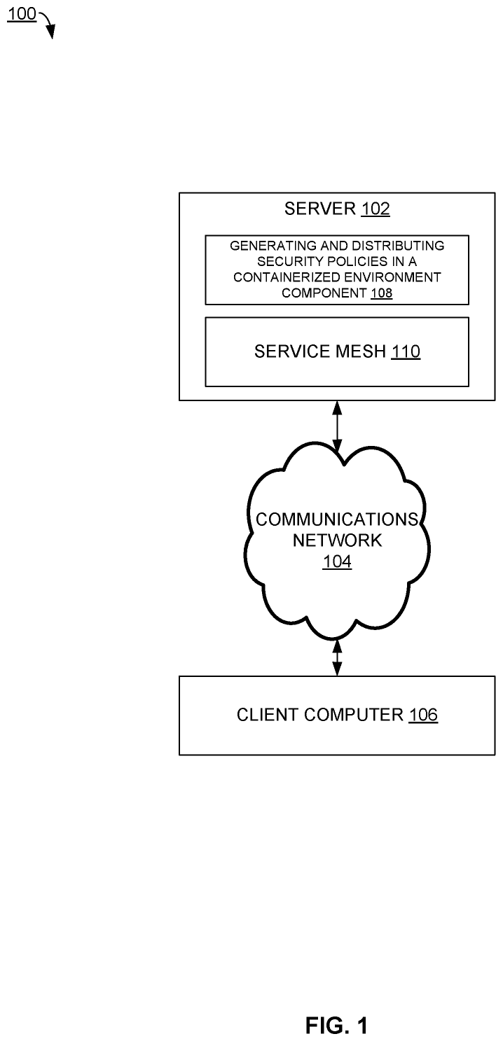

FIG. 1 illustrates an example system architecture 100 that can facilitate generating and distributing security policies in a containerized environment, in accordance with an embodiment of this disclosure.

System architecture 100 comprises server 102, communications network 104, and remote computer 106. In turn, server 102 comprises generating and distributing security policies in a containerized environment component 108, and service mesh 110.

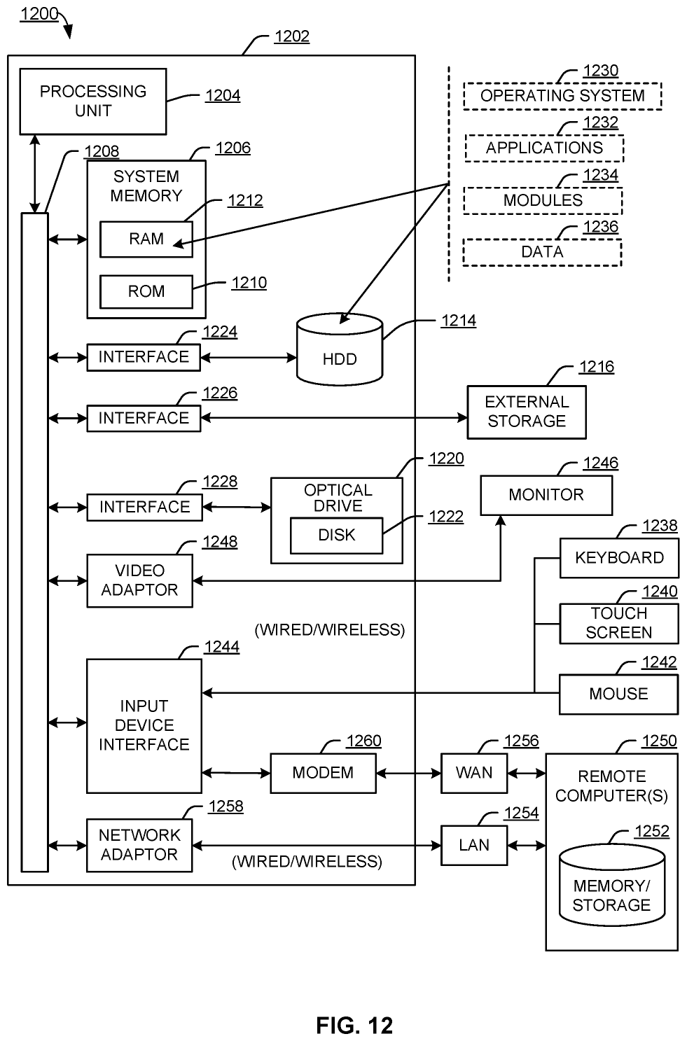

Each of server 102 and/or remote computer 106 can be implemented with part(s) of computing environment 1200 of FIG. 12. Communications network 104 can comprise a computer communications network, such as the Internet.

Service mesh 110 can comprise an infrastructure layer for facilitating between microservices that execute within respective containers.

Remote computer 106 can generate computer-executable code to create or update a microservice of service mesh 110. Generating and distributing security policies in a containerized environment component 108 can generate and then distribute one or more service policies for service mesh 110 based on this computer-executable code from remote computer 106.

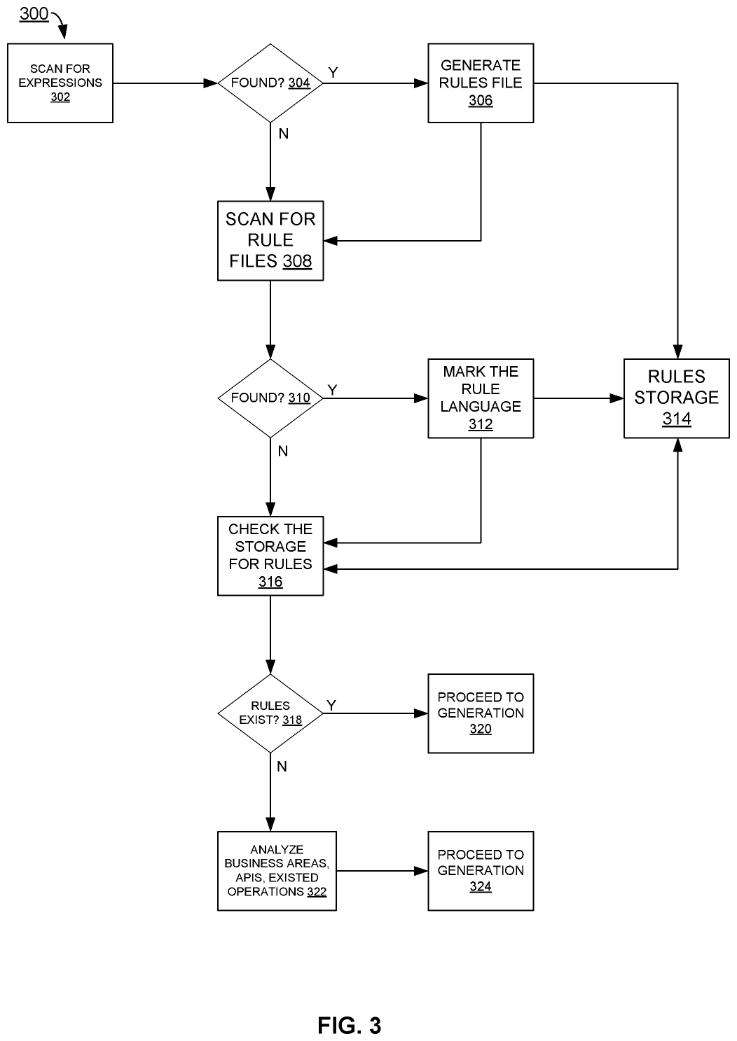

In some examples, generating and distributing security policies in a containerized environment component 108 can implement part(s) of the process flows of FIGS. 3-11 to implement generating and distributing security policies in a containerized environment.

It can be appreciated that system architecture 100 is one example system architecture for generating and distributing security policies in a containerized environment, and that there can be other system architectures that facilitate generating and distributing security policies in a containerized environment.

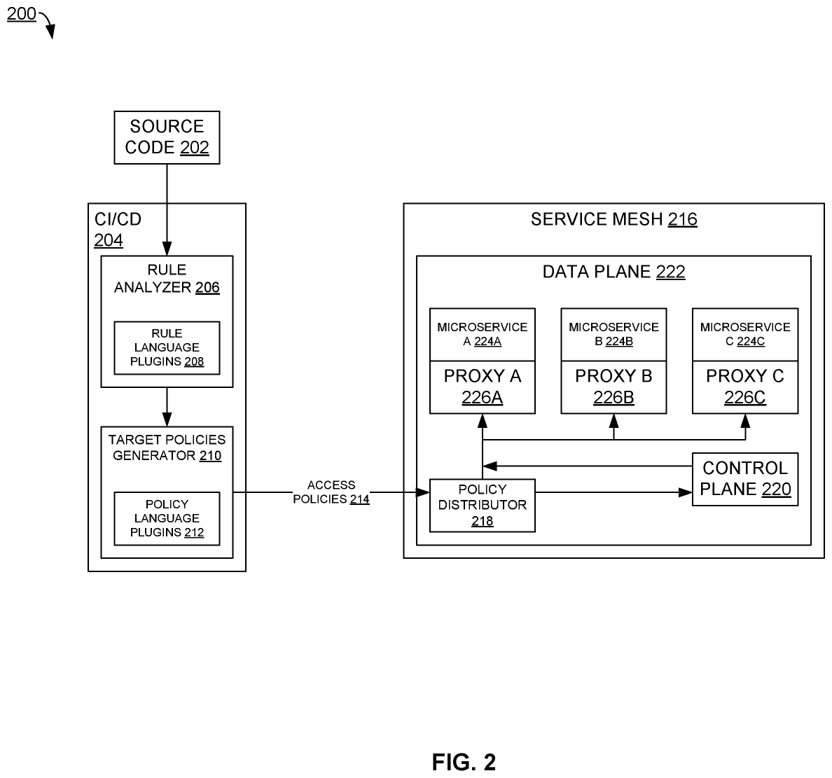

FIG. 2 illustrates another example system architecture 200 that can facilitate generating and distributing security policies in a containerized environment, in accordance with an embodiment of this disclosure. In some examples, part(s) of system architecture 200 can be used to implement part(s) of system architecture 100 of FIG. 1, such as part(s) of generating and distributing security policies in a containerized environment component 108.

System architecture 200 comprises source code 202, continuous integration/continuous deployment (CI/CD) 204, rule analyzer 206, rule language plugins 208, target policies generator 210, policy language plugins 212, access policies 214, service mesh 216, policy distributor 218, control plane 220, data plane 222, microservice A 224A, microservice B 224B, microservice C 224C, proxy A 226A, proxy B 226B, and proxy C 226C.

In an example, the present techniques can generally be divided into three parts: analyzing a microservice's repositories; generating access policies according to a target rule engine; and distributing new/changed policies to a target protected resource.

In some examples, these three parts can be implemented in three logical components—a rule analyzer component (such as rule analyzer 206), a target policy generator component (such as target policies generator 210), and a policy distributor component (such as by policy distributor 218). These can be side car proxies that are able to work with a rules engine, or relay a control plane of a container orchestrator and/or service mesh.

A rule analyzer component can be incorporated into a CI/CD ecosystem, and upon submission of code (e.g., source code 202), can figure out the source rules based on one or more of code structure (e.g., functional business area of the service, application programming interfaces (APIs), message handlers, and/or performed operations like read, write, and/or execute), expression markup language in the code, and rule files in one or more different formats. In doing so, rule language plugins 208 can be utilized, where a rule language plugin provides information on how to analyze rules for a particular computer programming language.

A target policy generator component can be incorporated into a CI/CD ecosystem. This component can get the information discovered by a rule analyzer component, and can generate a corresponding policy that matches a specific rule engine type, container orchestrator system, or service mesh, by creating policy files in a corresponding configuration or programming language of the protected environment. In doing so, policy language plugins 212 can be utilized, where a policy language plugin provides information on how to analyze policies expressed in a particular format.

A policy distributor component can run as part of a containerized environment. This component can get network policies generated by a target policy generator component, and can analyze what system part the policy should be applied to, as well as distribute the policies to the related service side car, and/or the target container orchestrator (or service mesh) control plane (where, in some examples, the service mesh and/or container orchestrator can apply the policies based on proprietary logic).

CI/CD 204 can generally comprise a component that integrates changes to code for a microservice, and then deploys an instance of the resulting microservice to service mesh 216. Control plane 220 can generally manage microservices of service mesh 216, and data plane 222 can generally facilitate using services offered by the microservices of service mesh 216 (such as an application).

Microservice A 224A, microservice B 224B, and microservice C 224C can comprise microservices that are configured to interact collectively to offer a computer service or application. Proxy A 226A, proxy B 226B, and proxy C 226C can comprise proxies of service mesh 216 that are used for communications between microservice A 224A, microservice B 224B, and microservice C 224C.

### Example Process Flows

FIG. 3 illustrates an example process flow 300 that can facilitate generating and distributing security policies in a containerized environment, in accordance with an embodiment of this disclosure. In some examples, one or more embodiments of process flow 300 can be implemented by generating and distributing security policies in a containerized environment component 108 of FIG. 1, rule analyzer 206 of FIG. 2, or computing environment 1200 of FIG. 12.

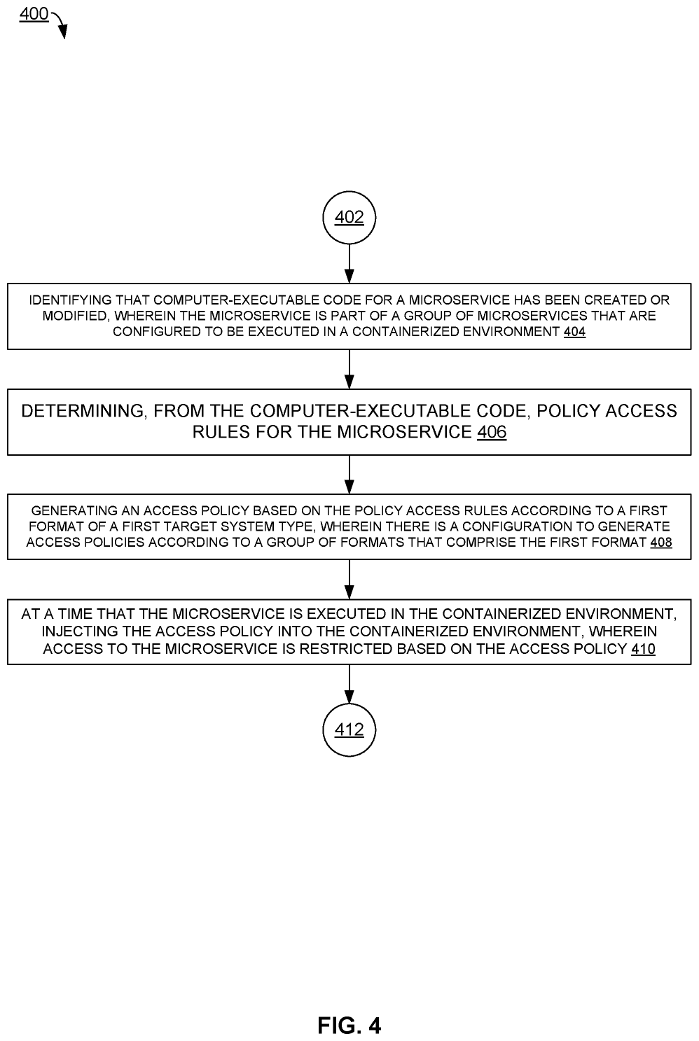

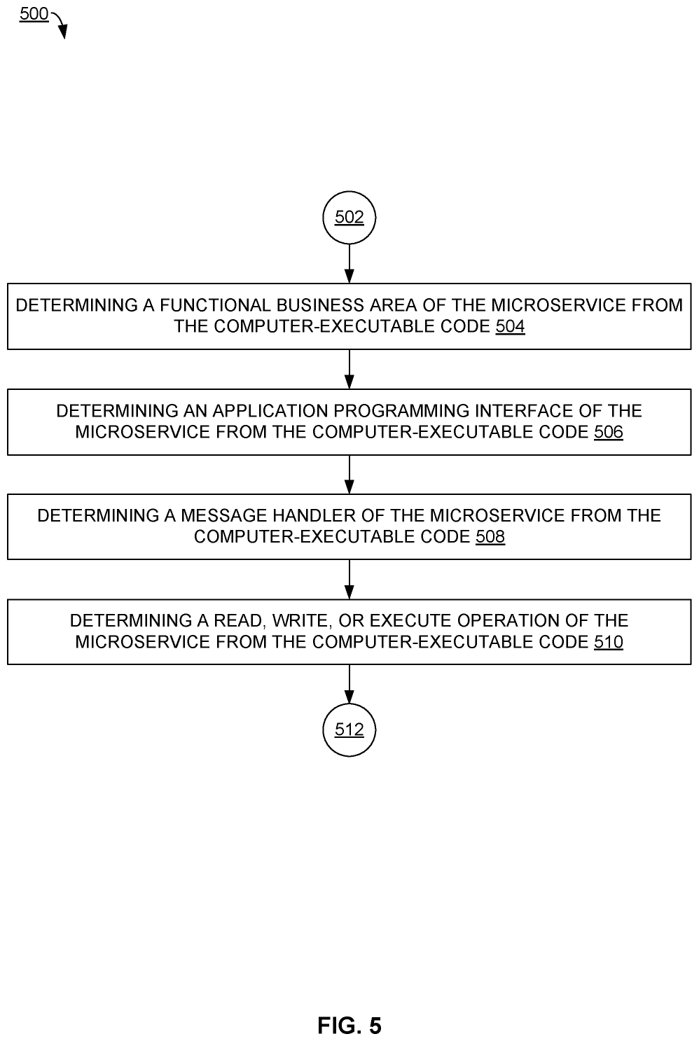

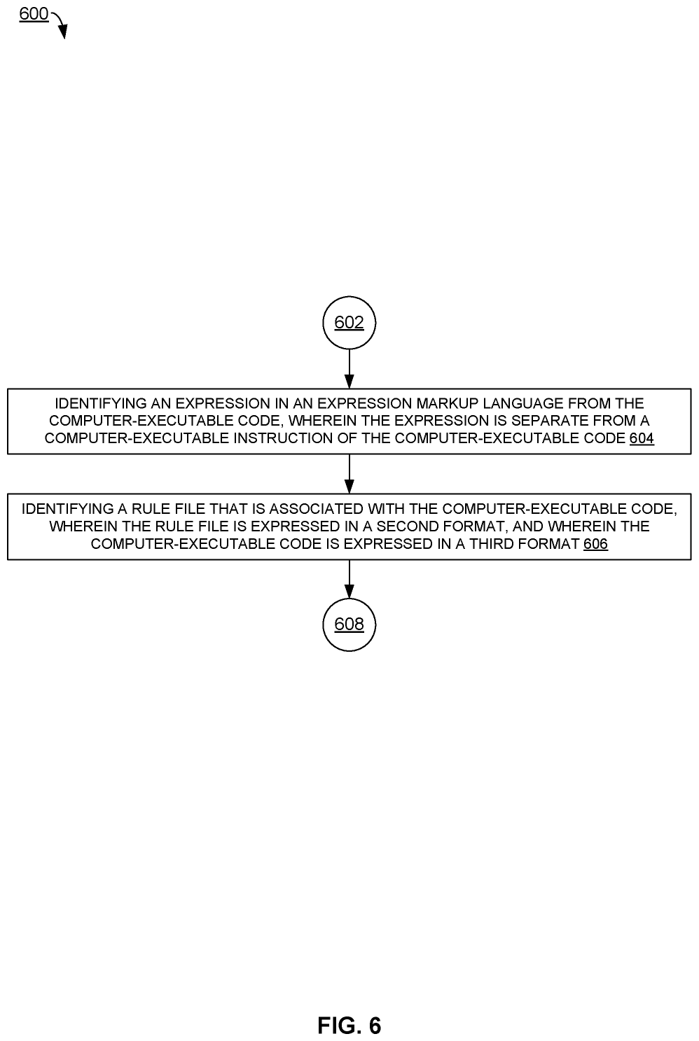

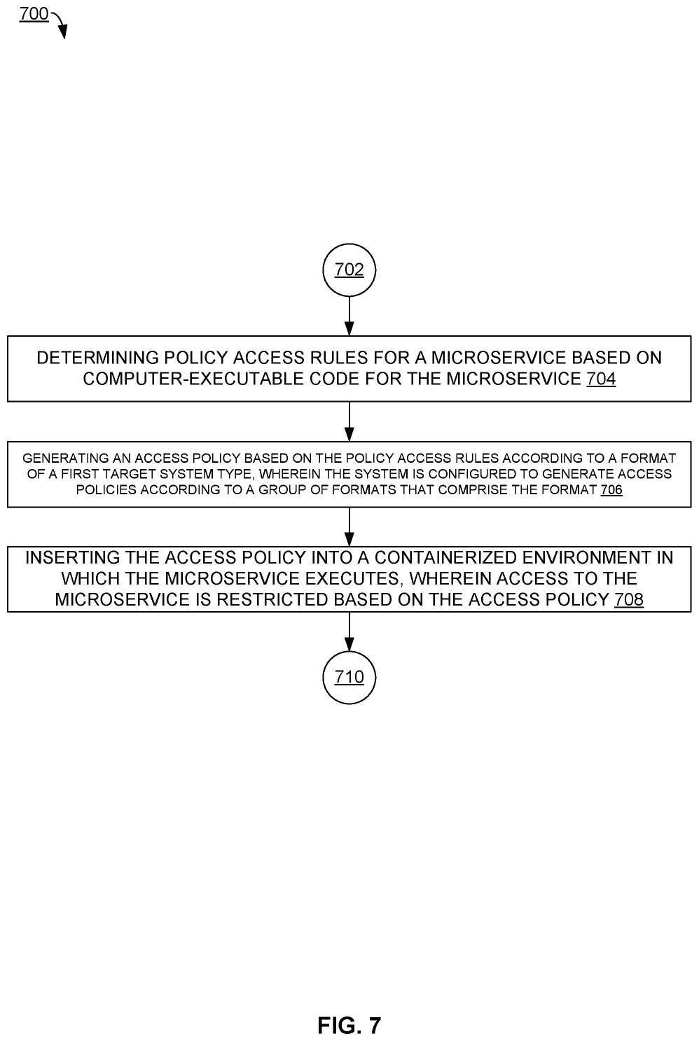

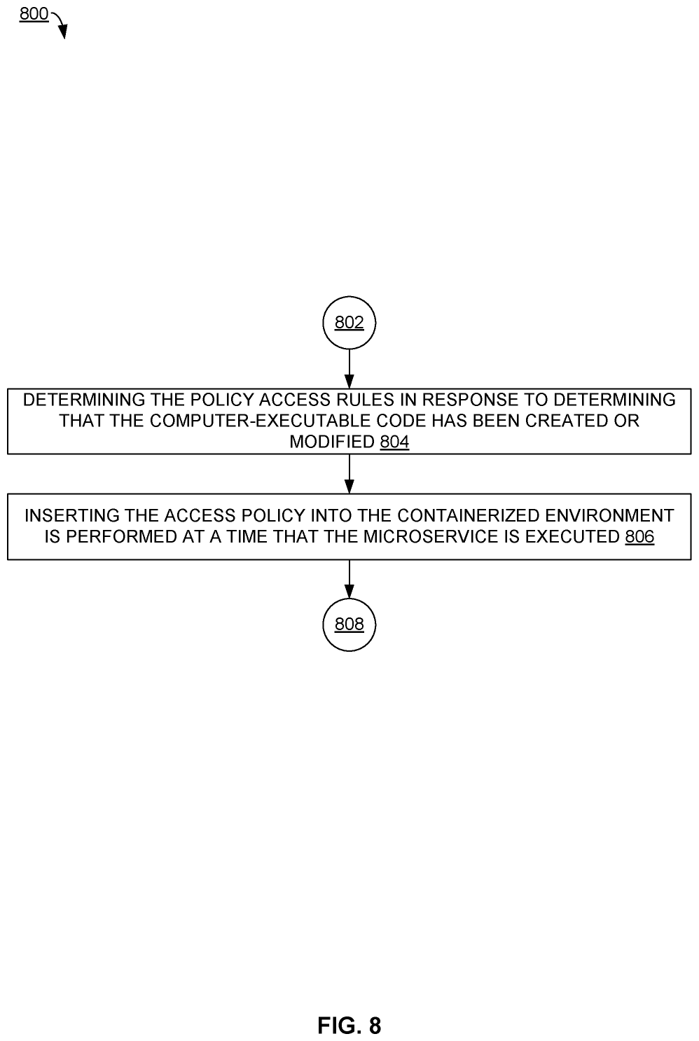

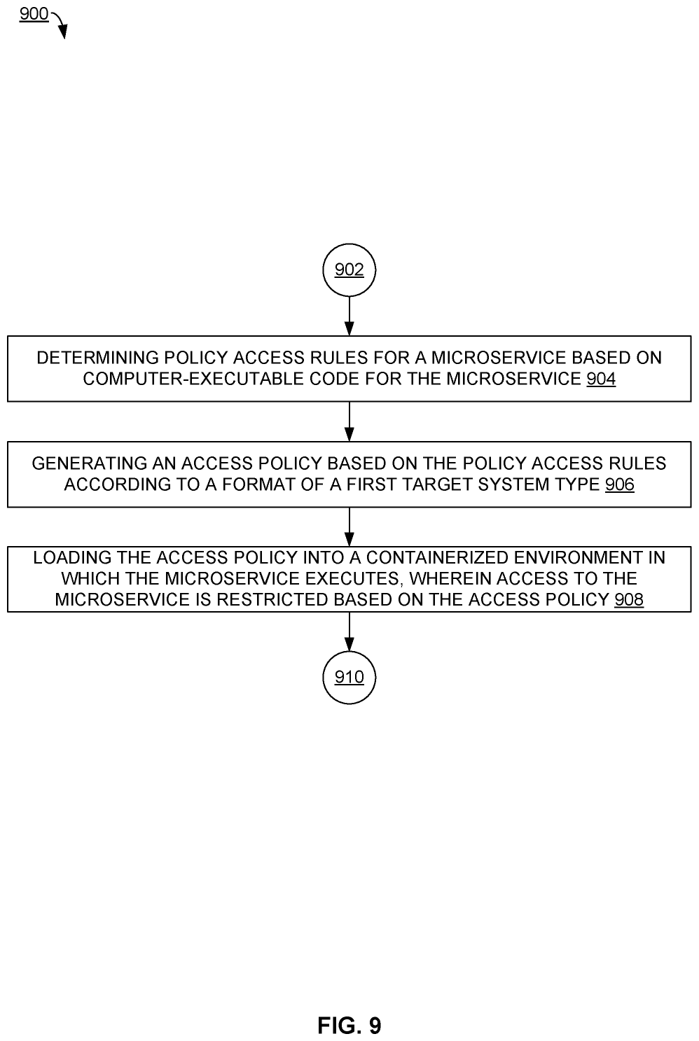

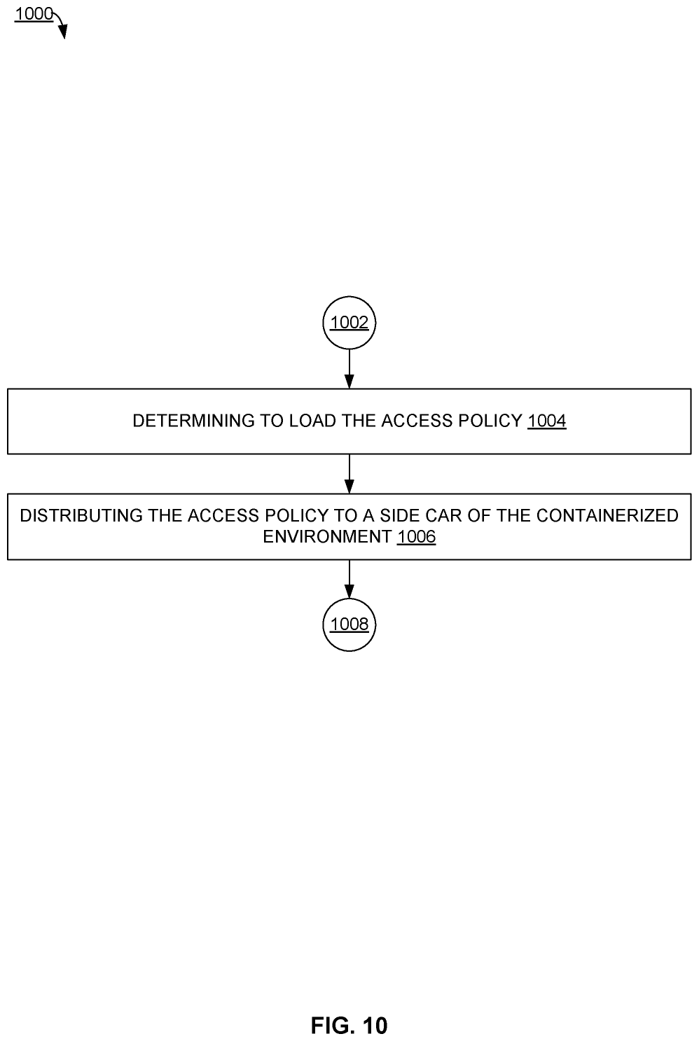

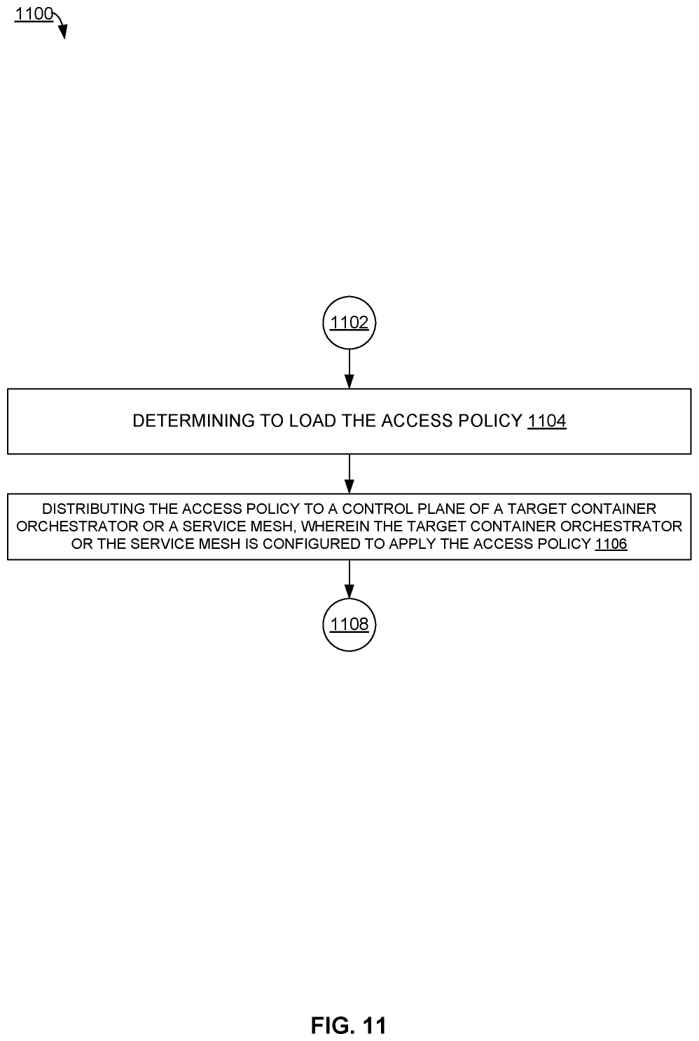

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, process flow 900 of FIG. 9, process flow 1000 of FIG. 10, and/or process flow 1100 of FIG. 11.

In some examples, analyzing a microservices network dependencies can be performed as follows. A rule analyzer component can gather some or more of the following information: attribute-based access control (ABAC) and RBAC defined rules in an expression markup language; rule files defined in a source code repository; business areas; resources; and existed operations (e.g., read, write, execute).

Process flow 300 begins with operation 302. Operation 302 depicts scanning for expressions. This can comprise scanning for rule files and expression in code (e.g., source code 202 of FIG. 2). After operation 302, process flow 300 moves to operation 304.

Operation 304 depicts determining whether expressions were found in operation 302. Where it is determined in operation 304 that expressions were found in operation 302, process flow 300 moves to operation 306. Instead, where it is determined in operation 304 that expressions were not found in operation 302, process flow 300 moves to operation 308.

Operation 306 is reached from operation 304 where it is determined that expressions were found in operation 302. Operation 306 depicts generating a rules file. This rules file can be generated based on the expressions found in operation 302. After operation 306, process flow 300 moves to operation 308 and operation 314.

Operation 308 is reached from operation 304 where it is determined that expressions were not found in operation 302, or from operation 306. Operation 308 depicts scanning for rule files. After operation 308, process flow 300 moves to operation 310.

Operation 310 depicts determining whether rule files were found in operation 308. Where it is determined in operation 310 that rule files were found in operation 308, process flow 300 moves to operation 312. Instead, where it is determined in operation 310 that rule files were not found in operation 308, process flow 300 moves to operation 316.

Operation 312 is reached from operation 310 where it is determined that rule files were found in operation 308. Operation 312 depicts marking the rule language. That is, a rule file can be associated with metadata that identifies a language in which the rules in the rule files are expressed. After operation 312, process flow 300 moves to operation 314, and operation 316.

Operation 314 is reached from operation 306, operation 312, and operation 316. Operation 314 depicts storing rules. These rules can be the rules file generated in operation 306, the rules file stored in operation 312, or checking rules storage for stored rules in operation 316.

Operation 316 is reached from operation 310 where it is determined that rule files were not found in operation 308, or from operation 312. Operation 312 depicts checking the rule storage for rules. This can comprise checking whether rules were stored as part of operation 314. After operation 316, process flow 300 moves to operation 318.

Operation 318 depicts determining whether rules exist. This can comprise determining whether a result of checking the storage for rules in operation 316 produced any results. Where it is determined in operation 318 that rules exist, process flow 300 moves to operation 320. Instead, where it is determined in operation 318 that rules do not exist, process flow 300 moves to operation 322.

Operation 320 is reached from operation 318 where it is determined that rules exist. Operation 320 depicts proceeding to generation. This can comprise generating a policy based on the rules files. After operation 320, process flow 300 ends.

Operation 322 is reached from operation 318 where it is determined that rules do not exist. Operation 322 depicts analyzing business area. APIs, and existing operations.

This can be accomplished by analyzing information such as a name of a microservice associated with the source code being evaluated; services accessed by the microservice; resources and hypertext transfer protocol (HTTP) methods where there is a representational state transfer (REST) architecture; and mutation, queries, and HTTP methods where there is a GraphQL query; message handlers invoked; and performed operations (e.g., read, write, execute).

For example, where the source code comprises a repository for a catalog service, a catalog administrator role can be derived from this information. For services, there can be products and sub-products, so additional roles can be derived from this information, such as products and sub-products administrators.

Actions can be derived from HTTP methods like GET, POST, PUT, and DELETE. For example, with a GET HTTP method, there can be a catalog, a product, and a sub-product viewer.

There can be a hierarchy in the source code. For example, a microservice associated with the source code can access service 1, which can access service 2. From this, a policy can be created that states that access to resource catalog/product/{id}/subproducts will be given to roles that have as part of a hierarchy sub-product viewer role.

Based on this information, a role based access control (RBAC) policy can be generated to protect resources. A RBAC policy can generally relate to an approach to restrict access to a computer resource to authorized user accounts, where user accounts can be associated with varying roles and privileges.

After operation 322, process flow 300 moves to operation 324.

Operation 324 depicts proceeding to generation. This can comprise generating a policy based on the business area. APIs, and existing operations of operation 322. After operation 324, process flow 300 ends.

A target policy generator component (e.g., target policies generator 210 of FIG. 2) can get the rules from the rule analyzer component and can generate the access policies accordingly to the specified targeting rule engine. Generation can be performed on a particular plugin layer. That is, a target policy generator component can perform operation 320 and/or operation 324.

A policy distributor component (e.g., policy distributor 218 of FIG. 2) can receive access policies from a target policy generator component, and can apply them against a target subsystem (such as a container orchestrator system, a service mesh, a side car, or a service).

In a container orchestrator or service mesh case, a policy distributor component can access an API of each container orchestrator system or service mesh that permit it to create resources, and use this API in order to create a network policy against a container orchestrator or service mesh that is present in the system.

In a rule engine case, a policy distributor component can use a specific rule engine API that has been adopted by a side car.

FIG. 4 illustrates an example process flow 400 that can facilitate generating and distributing security policies in a containerized environment, in accordance with an embodiment of this disclosure. In some examples, one or more embodiments of process flow 400 can be implemented by generating and distributing security policies in a containerized environment component 108 of FIG. 1, or computing environment 1200 of FIG. 12.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 300 of FIG. 3, process flow 500 of FIG. 5, process flow 600 of FIG. 6, process flow 700 of FIG. 7, process flow 800 of FIG. 8, process flow 900 of FIG. 9, process flow 1000 of FIG. 10, and/or process flow 1100 of FIG. 11.

Process flow 400 begins with 402, and moves to operation 404.

Operation 404 depicts identifying that computer-executable code for a microservice has been created or modified, wherein the microservice is part of a group of microservices that are configured to be executed in a containerized environment. That is, there can be a containerized environment where code for a microservice of the containerized environment has been created or modified. This can be similar to microservice A 224A, microservice B 224B, and microservice C 224C of FIG. 2, where these microservices execute within respective containers. The computer-executable code can be similar to source code 202.

After operation 404, process flow 400 moves to operation 406.

Operation 406 depicts determining, from the computer-executable code, policy access rules for the microservice. In some examples, this can be performed in a similar manner as operations 302-318 and 322 of FIG. 3.

In some examples, determining the policy access rules is performed in response to the computer-executable code being created or modified, and independently of the microservice being executed. That is, during deploy time, upon creation (or code change) of a microservice, the microservice's source code can be analyzed to determine access rules.

In some examples, determining the policy access rules for the microservice is performed by a continuous integration and continuous deployment component. That is, in some examples this can be performed by rule analyzer 206 of FIG. 2.

After operation 406, process flow 400 moves to operation 408.

Operation 408 depicts generating an access policy based on the policy access rules according to a first format of a first target system type, wherein there is a configuration to generate access policies according to a group of formats that comprise the first format. In some examples, this can be performed in a similar manner as operations 320 and 324 of FIG. 3. A system that implements process flow 400 can be configured to generate access policies according to a group of formats, such as those that correspond to multiple types of products that support microservice architectures. Here, the access policies can be generated in a first format that corresponds to an architecture of the target system on which an instance of the microservice will be deployed.

After operation 408, process flow 400 moves to operation 410.

Operation 410 depicts, at a time that the microservice is executed in the containerized environment, injecting the access policy into the containerized environment, wherein access to the microservice is restricted based on the access policy. That is, at runtime (and in contrast to at deploy time, where operations 404-408 can be implemented at deploy time), the access policy can be injected into the containerized policy. Using the example of FIG. 2, this can comprise injecting the access policy into one or more of proxy A 226A, proxy B 226B, and proxy C 226C, where proxy A 226A, proxy B 226B, and proxy C 226C are configured to enforce the access policy on behalf of their corresponding microservice (microservice A 224A, microservice B 224B, and microservice C 224C, respectively).

After operation 410, process flow 400 moves to 412, where process flow 400 ends.

FIG. 5 illustrates an example process flow 500 that can facilitate generating and distributing security policies in a containerized environment, in accordance with an embodiment of this disclosure. In some examples, one or more embodiments of process flow 500 can be implemented by generating and distributing security policies in a containerized environment component 108 of FIG. 1, or computing environment 1200 of FIG. 12.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 300 of FIG. 3, process flow 400 of FIG. 4, process flow 600 of FIG. 6, process flow 700 of FIG. 7, process flow 800 of FIG. 8, process flow 900 of FIG. 9, process flow 1000 of FIG. 10, and/or process flow 1100 of FIG. 11.

Process flow 500 begins with 502, and moves to operation 504.

Operation 504 depicts determining a functional business area of the microservice from the computer-executable code. That is, determining, from the computer-executable code, the policy access rules for the microservice, as in operation 406 of FIG. 4 can be determined from code structure, such as functional business areas of the microservice.

After operation 504, process flow 500 moves to operation 506.

Operation 506 depicts determining an application programming interface of the microservice from the computer-executable code. That is, determining, from the computer-executable code, the policy access rules for the microservice, as in operation 406 of FIG. 4 can be determined from code structure, such as APIs invoked in the code.

After operation 506, process flow 500 moves to operation 508.

Operation 508 depicts determining a message handler of the microservice from the computer-executable code. That is, determining, from the computer-executable code, the policy access rules for the microservice, as in operation 406 of FIG. 4 can be determined from code structure, such as a message handler invoked in the code.

After operation 508, process flow 500 moves to operation 510.

Operation 510 depicts determining a read, write, or execute operation of the microservice from the computer-executable code. That is, determining, from the computer-executable code, the policy access rules for the microservice, as in operation 406 of FIG. 4 can be determined from code structure, such as operations (e.g., read, write, execute) invoked in the code.

After operation 410, process flow 500 moves to 512, where process flow 500 ends.

FIG. 6 illustrates an example process flow 600 that can facilitate generating and distributing security policies in a containerized environment, in accordance with an embodiment of this disclosure. In some examples, one or more embodiments of process flow 600 can be implemented by generating and distributing security policies in a containerized environment component 108 of FIG. 1, or computing environment 1200 of FIG. 12.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 300 of FIG. 3, process flow 400 of FIG. 4, process flow 500 of FIG. 5, process flow 700 of FIG. 7, process flow 800 of FIG. 8, process flow 900 of FIG. 9, process flow 1000 of FIG. 10, and/or process flow 1100 of FIG. 11.

Process flow 600 begins with 602, and moves to operation 604.

Operation 604 depicts identifying an expression in an expression markup language from the computer-executable code, wherein the expression is separate from a computer-executable instruction of the computer-executable code. That is, determining, from the computer-executable code, the policy access rules for the microservice, as in operation 406 of FIG. 4 can be determined from expression markup language expressions that are found in the code.

After operation 604, process flow 600 moves to operation 606.

Operation 606 depicts identifying a rule file that is associated with the computer-executable code, wherein the rule file is expressed in a second format, and wherein the computer-executable code is expressed in a third format. That is, determining, from the computer-executable code, the policy access rules for the microservice, as in operation 406 of FIG. 4 can be determined from rules files expressed in one or more formats and that are associated with the computer-executable code.

After operation 606, process flow 600 moves to 608, where process flow 600 ends.

FIG. 7 illustrates an example process flow 700 that can facilitate generating and distributing security policies in a containerized environment, in accordance with an embodiment of this disclosure. In some examples, one or more embodiments of process flow 700 can be implemented by generating and distributing security policies in a containerized environment component 108 of FIG. 1, or computing environment 1200 of FIG. 12.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 300 of FIG. 3, process flow 400 of FIG. 4, process flow 500 of FIG. 5, process flow 600 of FIG. 6, process flow 800 of FIG. 8, process flow 900 of FIG. 9, process flow 1000 of FIG. 10, and/or process flow 1100 of FIG. 11.

Process flow 700 begins with 702, and moves to operation 704.

Operation 704 depicts determining policy access rules for a microservice based on computer-executable code for the microservice. In some examples, operation 704 can be implemented in a similar manner as operation 406 of FIG. 4.

After operation 704, process flow 700 moves to operation 706,

Operation 706 depicts generating an access policy based on the policy access rules according to a format of a first target system type, wherein the system is configured to generate access policies according to a group of formats that comprise the format.

In some examples, generating the access policy is performed by a continuous integration and continuous deployment component. That is generating the access policy can be performed by CI/CD 204 of FIG. 2.

In some examples, the format comprises the format for a rule engine, a format for a container orchestrator system, or a container for a service mesh. That is, a policy can be generated that matches a specific rule engine type, container orchestrator system type, or service mesh type.

After operation 706, process flow 700 moves to operation 708,

Operation 708 depicts inserting the access policy into a containerized environment in which the microservice executes, wherein access to the microservice is restricted based on the access policy.

After operation 708, process flow 700 moves to 710, where process flow 700 ends.

FIG. 8 illustrates an example process flow 800 that can facilitate generating and distributing security policies in a containerized environment, in accordance with an embodiment of this disclosure. In some examples, one or more embodiments of process flow 800 can be implemented by generating and distributing security policies in a containerized environment component 108 of FIG. 1, or computing environment 1200 of FIG. 12.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 900 of FIG. 9, process flow 1000 of FIG. 10, and/or process flow 1100 of FIG. 11.

Process flow 800 begins with 802, and moves to operation 804.

Operation 804 depicts determining the policy access rules in response to determining that the computer-executable code has been created or modified. That is, rule analyzer 206 of FIG. 2 can operate at deploy time for code.

After operation 804, process flow 800 moves to operation 806.

Operation 806 depicts inserting the access policy into the containerized environment is performed at a time that the microservice is executed. That is, policy distributor 218 of FIG. 2 can operate at run time for code.

After operation 806, process flow 800 moves to 808, where process flow 800 ends.

FIG. 9 illustrates an example process flow 900 that can facilitate generating and distributing security policies in a containerized environment, in accordance with an embodiment of this disclosure. In some examples, one or more embodiments of process flow 900 can be implemented by generating and distributing security policies in a containerized environment component 108 of FIG. 1, or computing environment 1200 of FIG. 12.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 800 of FIG. 8, process flow 1000 of FIG. 10, and/or process flow 1100 of FIG. 11.

Process flow 900 begins with 902, and moves to operation 904.

Operation 904 depicts determining policy access rules for a microservice based on computer-executable code for the microservice. In some examples, operation 904 can be implemented in a similar manner as operation 406 of FIG. 4.

In some examples, a group of microservices comprises the microservice, the group of microservices is configured to collectively provide a computing service, and respective microservices of the group of microservices are configured to inter-communicate according to a protocol.

In some examples, a group of microservices comprises the microservice, respective microservices of the group of microservices execute within respective containers, and the respective containers store respective libraries or dependencies utilized by the respective microservices, independently of storing an operating system.

In some examples, determining the policy access rules and generating the access policy is performed by a continuous integration and continuous deployment component that is configured to deploy the microservice, and the continuous integration and continuous deployment component is configured to integrate code changes from multiple sources and to deploy code to production. That is, this can be performed by CI/CD 204 of FIG. 2.

After operation 904, process flow 900 moves to operation 906.

Operation 906 depicts generating an access policy based on the policy access rules according to a format of a first target system type. In some examples, operation 906 can be implemented in a similar manner as operation 408 of FIG. 4.

After operation 906, process flow 900 moves to operation 908.

Operation 908 depicts loading the access policy into a containerized environment in which the microservice executes, wherein access to the microservice is restricted based on the access policy. In some examples, operation 908 can be implemented in a similar manner as operation 410 of FIG. 4.

After operation 908, process flow 900 moves to 910, where process flow 900 ends.

FIG. 10 illustrates an example process flow 1000 that can facilitate generating and distributing security policies in a containerized environment, in accordance with an embodiment of this disclosure. In some examples, one or more embodiments of process flow 1000 can be implemented by generating and distributing security policies in a containerized environment component 108 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 800 of FIG. 8, process flow 900 of FIG. 9, and/or process flow 1100 of FIG. 11.

Process flow 1000 begins with 1002, and moves to operation 1004.

Operation 1004 depicts determining to load the access policy. This can be performed at a time of deploying a microservice to a service mesh, such as deploying microservice A 224A of FIG. 2, based on source code 202.

After operation 1004, process flow 1000 moves to operation 1006.

Operation 1006 depicts distributing the access policy to a side car of the containerized environment. In some examples, this side car can be similar to proxy A 226A of FIG. 2, which corresponds to microservice A 224A.

After operation 1006, process flow 1000 moves to 1008, where process flow 1000 ends.

FIG. 11 illustrates an example process flow 1100 that can facilitate generating and distributing security policies in a containerized environment, in accordance with an embodiment of this disclosure. In some examples, one or more embodiments of process flow 1100 can be implemented by generating and distributing security policies in a containerized environment component 118 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 1100 begins with 1102, and moves to operation 1104.

Operation 1104 depicts determining to load the access policy. In some examples, operation 1104 can be implemented in a similar manner as operation 1004 of FIG. 10.

After operation 1104, process flow 1100 moves to operation 1106.

Operation 1106 depicts distributing the access policy to a control plane of a target container orchestrator or a service mesh, wherein the target container orchestrator or the service mesh is configured to apply the access policy. This can be similar to service mesh 216 or control plane 220, respectively, of FIG. 2.

After operation 1106, process flow 1100 moves to 1108, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of server 102 and/or remote computer 106 of FIG. 1.

In some examples, computing environment 1200 can implement one or more embodiments of the process flows of FIGS. 3-11 to facilitate generating and distributing security policies in a containerized environment.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component.” “module,” “system,” “interface.” “cluster,” “server.” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory coupled to the processor, comprising instructions that, in response to execution by the processor, cause the system to perform operations, comprising:
identifying that computer-executable code for a microservice has been created or modified, wherein the microservice is part of a group of microservices that are configured to be executed in a containerized environment;
determining, from the computer-executable code, policy access rules for the microservice;
generating an access policy based on the policy access rules according to a first format of a first target system type, wherein the system is configured to generate access policies according to a group of formats that comprise the first format; and
at a time that the microservice is executed in the containerized environment, injecting the access policy into the containerized environment, wherein access to the microservice is restricted based on the access policy.

2. The system of claim 1, wherein determining the policy access rules is performed in response to the computer-executable code being created or modified, and independently of the microservice being executed.

3. The system of claim 1, wherein determining the policy access rules for the microservice is performed by a continuous integration and continuous deployment component.

4. The system of claim 1, wherein determining, from the computer-executable code, the policy access rules for the microservice comprises:
determining a functional business area of the microservice from the computer-executable code.

5. The system of claim 1, wherein determining, from the computer-executable code, the policy access rules for the microservice comprises:
determining an application programming interface of the microservice from the computer-executable code.

6. The system of claim 1, wherein determining, from the computer-executable code, the policy access rules for the microservice comprises:
determining a message handler of the microservice from the computer-executable code.

7. The system of claim 1, wherein determining, from the computer-executable code, the policy access rules for the microservice comprises:
determining a read, write, or execute operation of the microservice from the computer-executable code.

8. The system of claim 1, wherein determining, from the computer-executable code, the policy access rules for the microservice comprises:
identifying an expression in an expression markup language from the computer-executable code, wherein the expression is separate from a computer-executable instruction of the computer-executable code.

9. The system of claim 1, wherein determining, from the computer-executable code, the policy access rules for the microservice comprises:
identifying a rule file that is associated with the computer-executable code, wherein the rule file is expressed in a second format, and wherein the computer-executable code is expressed in a third format.

10. A method, comprising:
determining, by a system comprising a processor, policy access rules for a microservice based on computer-executable code for the microservice;
generating, by the system, an access policy based on the policy access rules according to a format of a first target system type, wherein the system is configured to generate access policies according to a group of formats that comprise the format; and
inserting, by the system, the access policy into a containerized environment in which the microservice executes, wherein access to the microservice is restricted based on the access policy.

11. The method of claim 10, wherein determining the policy access rules is performed in response to determining that the computer-executable code has been created or modified.

12. The method of claim 10, wherein inserting the access policy into the containerized environment is performed at a time that the microservice is executed.

13. The method of claim 10, wherein generating the access policy is performed by a continuous integration and continuous deployment component.

14. The method of claim 10, wherein the format comprises the format for a rule engine, a format for a container orchestrator system, or a container for a service mesh.

15. A non-transitory computer-readable medium comprising instructions that, in response to execution, cause a system comprising a processor to perform operations, comprising:
determining policy access rules for a microservice based on computer-executable code for the microservice;
generating an access policy based on the policy access rules according to a format of a first target system type; and
loading the access policy into a containerized environment in which the microservice executes, wherein access to the microservice is restricted based on the access policy.

16. The non-transitory computer-readable medium of claim 15, wherein loading the access policy comprises:
distributing the access policy to a side car of the containerized environment.

17. The non-transitory computer-readable medium of claim 15, wherein loading the access policy comprises:
distributing the access policy to a control plane of a target container orchestrator or a service mesh, wherein the target container orchestrator or the service mesh is configured to apply the access policy.

18. The non-transitory computer-readable medium of claim 15, wherein a group of microservices comprises the microservice, wherein the group of microservices is configured to collectively provide a computing service, and wherein respective microservices of the group of microservices are configured to inter-communicate according to a protocol.

19. The non-transitory computer-readable medium of claim 15, wherein a group of microservices comprises the microservice, wherein respective microservices of the group of microservices execute within respective containers, and wherein the respective containers store respective libraries or dependencies utilized by the respective microservices, independently of storing an operating system.

20. The non-transitory computer-readable medium of claim 15, wherein determining the policy access rules and generating the access policy is performed by a continuous integration and continuous deployment component that is configured to deploy the microservice, and wherein the continuous integration and continuous deployment component is configured to integrate code changes from multiple sources and to deploy code to production.
